(19) United States
(12) Patent Application Publication
(10) Pub. No.: US 2013/0133800 A1
(43) Pub. Date: May 30, 2013

(54) SYSTEM FOR ATTACHING AN ELECTRONIC DEVICE OR OTHER ITEM TO A PNEUMATIC TIRE

(71) Applicant: Jean-Claude Patrice Philippe Griffoin, Mertzig (LU)

(72) Inventor: Jean-Claude Patrice Philippe Griffoin, Mertzig (LU)

(21) Appl. No.: 13/305,879

(22) Filed: Nov. 29, 2011

(51) Int. Cl. B60C 5/00; B29D 30/06

(52) U.S. Cl. 152/450; 156/123; 156/394.1

(57) ABSTRACT

A pneumatic tire includes an innerliner forming an internal cavity and an enveloping member. The innerliner maintains pneumatic pressure within the internal cavity. The enveloping member defines a pocket for removably receiving and removably securing an item to the pneumatic tire. The enveloping member is cured simultaneously with the innerliner to secure the enveloping member to the innerliner for the operational life of the pneumatic tire.

### FIELD OF INVENTION

The present invention relates generally to a pneumatic tire, and more particularly, a system, apparatus, and method for removably securing an electronic device to the pneumatic tire.

### BACKGROUND OF THE PRESENT INVENTION

The use of electronic devices or modules in tires enables numerous applications for acquiring, storing, and/or transmitting data for the purpose of monitoring the manufacture or logistics, and more generally, for informing an operator about the evolution of the tire's performance characteristics throughout the functional life of the tire.

An electronic monitoring module may comprise active components connected to an autonomous electrical energy supply, such as batteries or an inductive coupling system. The monitoring module may exchange information with an external module, which may serve as a user interface via radio waves, the frequency and power of which may be determined by specific transmission protocols. The module may generally be arranged inside a flexible or rigid protective cover intended to protect the electronic components from aggression related to external/internal shocks and the atmosphere inside the tire.

The conventional module, positioned inside the cavity formed by the tire once it is fitted on the wheel, may be arranged at a variety of locations. Thus, the module may be fixed to the valve, fixed on the wheel rim, fixed or bonded to an inside wall of the tire, or even integrated into the components of the tire. The choice between these locations may depend on the nature of the tire and the forces to which the tire may be subjected, on the nature of the module's energy source, on the information to be monitored, and on the accessibility desired for maintenance of the module.

One conventional method in arranges elastic pockets on the inside wall of the tire. However, these pockets are positioned after the tire has been completed. This requires another step of preparing the part of the surface which is to receive the support or elastic cavity and then bonding or vulcanizing the support onto that part of the surface.

### SUMMARY OF THE PRESENT INVENTION

A pneumatic tire in accordance with the present invention includes an innerliner forming an internal cavity and an enveloping member. The innerliner maintains pneumatic pressure within the internal cavity. The enveloping member defines a pocket for removably receiving and removably securing an item to the pneumatic tire. The enveloping member is cured simultaneously with the innerliner to secure the enveloping member to the innerliner for the operational life of the pneumatic tire.

According to another aspect of the pneumatic tire, the item is a wireless electronic module.

According to still another aspect of the pneumatic tire, the item has a cylindrical shape.

According to yet another aspect of the pneumatic tire, the enveloping member has a rectangular shape.

According to still another aspect of the pneumatic tire, the item is part of a tire pressure monitoring system.

A method in accordance with the present invention secures an item to a pneumatic tire. The method comprises the steps of: providing a green tire and an uncured enveloping member; simultaneously curing the enveloping member to an innerliner of the green tire such that one edge and the interior of the enveloping member is not attached to the innerliner thereby forming a pocket; inserting an item into the pocket by moving the item in a first direction through a mouth defined by the one unattached end of the enveloping member and an adjacent portion of the innerliner; and subsequently removing the item from the pocket by moving the item in an opposite second direction through the mouth.

According to another aspect of the method, the method further includes the step of balancing the pneumatic tire by inserting the item into the pocket.

According to still another aspect of the method, the method further includes the step of positioning the enveloping member along a centerline of the pneumatic tire.

According to yet another aspect of the method, the method further includes the step of securing the item in the pocket by deflecting of the one unattached edge of the enveloping member toward the innerliner.

According to still another aspect of the method, the method further includes the step of reducing noise of the rotating pneumatic tire by inserting the item into the pocket.

A system in accordance with the present invention secures an item to a pneumatic tire. The system includes an innerliner layer and an enveloping member defining a pocket for removably receiving and removably securing an item to the pneumatic tire. The enveloping member is cured simultaneously with the innerliner layer to secure the enveloping member to the innerliner layer for the operational life of the pneumatic tire. The enveloping member is simultaneously cured with the innerliner layer such that one edge and an interior of the enveloping member is not attached to the innerliner layer thereby forming a pocket. The pocket surrounds the item on at least two sides thereby securing the item to the pneumatic tire.

According to another aspect of the system, the item is inserted into the pocket by moving the item in a first direction through a mouth defined by the one unattached end of the enveloping member and an adjacent portion of the innerliner layer.

According to still another aspect of the system, the item is subsequently removed from the pocket by moving the item in an opposite second direction through the mouth.

According to yet another aspect of the system, the enveloping member is shaped to correspond to a shape of the item.

According to still another aspect of the system, the item is secured within the pocket by a deflection of the one unattached edge of the enveloping member toward the innerliner.

### DEFINITIONS

The following definitions are controlling for the disclosed invention.

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF DRAWINGS

The description below is intended to explain non-limiting example embodiments of a tire according to the present invention, with reference to the figures, in which:

FIG. 1 shows a schematic partial cross-sectional view of a tire with an example attachment in accordance with the present invention; and

FIG. 2 shows a schematic partial cross sectional view of the example embodiment of FIG. 1 under a different condition.

### DETAILED DESCRIPTION OF EXAMPLE EMBODIMENTS

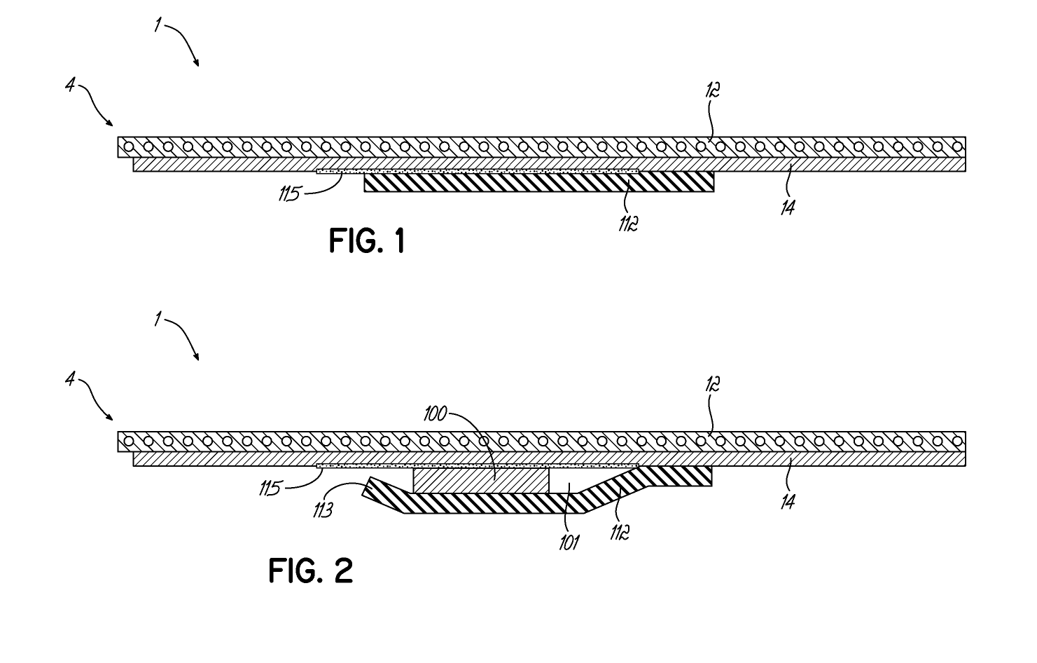

FIG. 1 is a partial cross-sectional view of an example pneumatic tire for use with the present invention. An example tire may be the tire disclosed by U.S. Pat. No. 7,789,119 to Agostini et al., herein incorporated by reference. Another example tire may be mounted on a tire rim, designed to be capable of continued operation during inflated and/or uninflated conditions. The example tire may have a reinforcing carcass ply extending from one bead area of the tire to an opposing bead area. The ends of the carcass ply may be turned axially inward to axially outward about bead cores and bead apexes. Terminal ends of the carcass ply may extend past radially outer ends of the bead apexes thereby enveloping the bead apexes.

Located in each sidewall region of the example tire may be a sidewall insert. The sidewall insert may be alternatively disposed adjacent to a tire innerliner or axially outward of the carcass ply. The sidewall insert may be formed of elastomeric material and may extend from a crown area of the example tire, from radially inward of a belt reinforcement structure to radially inward of terminal ends of the bead apexes. The elastomeric material of the sidewall insert, or wedge, may be selected to provide the example tire with support during uninflated, or runflat, operation of the tire.

The belt reinforcement structure, disposed radially outward of the carcass ply, may have at least two inclined, crossed cord plies. The cords of the inclined plies may be inclined with respect to a circumferential direction of the example tire. The cords of radially adjacent plies may further be inclined at similar, but opposing, angles to each other.

Outward of the belt reinforcement structure may be an overlay. The overlay may have an axial width equal to, or greater than, a maximum axial width of the crossed cord plies of the belt reinforcement structure, thereby encapsulating the crossed cord plies between the overlay and the carcass ply. The overlay may be reinforced with cords inclined at angles of 0°-15° relative to an equatorial plane of the example tire.

FIG. 1 shows an example partial cross-sectional view through a sidewall region 4 of a tire 1. The sidewall region 4 may include an innerliner 14 and a carcass ply 12. In accordance with the present invention, one or more electronic devices or items 100 may be secured to the tire 1 by a pocket 101 created by an enveloping member 112 which is also secured to the innerliner 14 of the tire. The pocket 101 may have an opening in one direction (FIG. 2) or in two opposite directions (not shown). The items 100 may be any shape, such as cylindrical, rectangular, spherical, etc. The enveloping members 112 may be any shape, such as circular, rectangular, pentagonal, etc. with one edge or one part of an edge unattached to the innerliner 14. The shape of the enveloping members 112 may correspond to the shape of the items 100.

The items 100 may be wireless pressure sensors, accelerometer, RFID's, pressure regulators, and/or modules and also balancing weights, foam for noise/vibration reduction, etc. Conventional methods typically involved gluing the sensors or other components to an innerliner, which necessitates preparation of the innerliner surface prior to applying the glue (e.g., cleaning by buffing or cleaning by chemicals or by laser/plasma, etc.).

Such an enveloping member 112 and item 100 may be used as part of a tire pressure monitoring system, an air maintenance tire, a reduced noise tire, a tire balancing method, etc. The enveloping member 112 may be secured to the innerliner 14 by simultaneous curing of the tire 1 with the enveloping member. No permanent adhesive and no cleaning or buffing of the surface of the innerliner is required thereby lowering cost of the tire 1, simplifying manufacturing of the tire, and improving balance of the tire. Further, the attachment of a module 100 by an enveloping member 112 in no way affects tire integrity while also allowing replacement of the module with no component modifications.

An enveloping member 112 may be positioned on the innerliner 14 along the tire centerline, radially outward of the bead area, in either shoulder area of the tire, etc. The enveloping member 112 may be oriented in order to form a pocket 101 opening in either or both radial directions, either or both axial directions, either or both circumferential directions, and/or any orientation therebetween. Thus, an enveloping member 112 may be placing anywhere inside the tire cavity and in any orientation. The enveloping member 112 may be sized for the item 100 to be secured.

As shown in FIG. 2, an outer edge 113 of the enveloping member 112 may deflect to partially or completely (not shown) close the pocket 101 to secure the item 100 from exiting the open end of the pocket. The item 100 may be removed at any time and replaced, as desired. By placing three or more enveloping members 112 on an innerliner 14, the position that optimizes tire balance may be selectively chosen for an item 100.

A green enveloping member 112 of the same material or similar material (e.g., ply material) as the innerliner 14 may be placed in a green tire and simultaneously cured with the green tire to produce such a structure. A spacer member, or sticker 115, may be located in the pocket 101 to temporarily secure the enveloping member 112 to the green tire before curing and to facilitate opening of the pocket after curing. The placement of the enveloping members 112 may not affect the cure cycle time as long as the enveloping members are not placed proximate to the point of least cure. The weight added to the tire 1 may be negligible.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A cured pneumatic tire comprising:
an item;
an innerliner forming an internal cavity, the innerliner maintaining pneumatic pressure within the internal cavity;
an enveloping member defining a pocket for removably receiving and removably securing the item to the pneumatic tire, the enveloping member being cured simultaneously with the innerliner to secure the enveloping member to the innerliner for the operational life of the pneumatic tire; and
a spacer member located adjacent the innerliner and enveloping member to temporarily secure the enveloping member to the green tire before curing and to facilitate opening of the pocket after curing, the enveloping member being positioned on the innerliner along a tire centerline, radially outward of a shoulder area of the tire, the enveloping member being oriented in order to form the pocket opening in a circumferential direction,
an outer edge of the enveloping member deflecting to close the pocket for securing the item from exiting the pocket.

2. The pneumatic tire as set forth in claim 1 wherein the item is a wireless electronic module.

3. The pneumatic tire as set forth in claim 1 wherein the item has a cylindrical shape.

4. The pneumatic tire as set forth in claim 1 wherein the enveloping member has a rectangular shape.

5. The pneumatic tire as set forth in claim 1 wherein the item is part of a tire pressure monitoring system.

6. A method for securing an item to, and removing the item from, a cured pneumatic tire, the method comprising the steps of:
providing a green tire, a spacer member, and an uncured enveloping member;
positioning the enveloping member on an innerliner of the green tire along a tire centerline of the green tire, radially outward of a shoulder area of the green tire;
orienting the enveloping member in order to form the pocket opening in a circumferential direction;
simultaneously curing the enveloping member to an innerliner of the green tire such that one edge and the interior of the enveloping member is not attached to the innerliner thereby forming a pocket with the spacer member therein;
inserting an item into the pocket by moving the item in a first direction through a mouth defined by the one unattached end of the enveloping member and an adjacent portion of the innerliner;
deflecting an outer edge of the enveloping member to close the pocket for securing the item from exiting the pocket during rotation of the cured pneumatic tire; and
subsequently removing the item from the pocket by moving the item in an opposite second direction through the mouth.

7. The method as set forth in claim 6 further including the step of balancing the pneumatic tire by inserting the item into the pocket.

8. (canceled)

9. (canceled)

10. The method as set forth in claim 6 further including the step of reducing noise of the rotating pneumatic tire by inserting the item into the pocket.

11. A system for securing an item to, and removing the item from, a cured pneumatic tire comprising:
an innerliner layer;
an enveloping member defining a pocket for removably receiving and removably securing an item to the pneumatic tire, the enveloping member being cured simultaneously with the innerliner layer to secure the enveloping member to the innerliner layer for the operational life of the pneumatic tire; and
a spacer member located adjacent the innerliner layer and enveloping member to temporarily secure the enveloping member to the green tire before curing and to facilitate opening of the pocket after curing, the enveloping member being positioned on the innerliner layer along a tire centerline, radially outward of a shoulder area of the tire, the enveloping member being oriented in order to form the pocket opening in a circumferential direction,
the enveloping member being simultaneously cured with the innerliner layer such that one edge and an interior of the enveloping member is not attached to the innerliner layer thereby forming a pocket, the pocket surrounding the item on at least two sides thereby securing the item to the pneumatic tire, an outer edge of the enveloping member deflecting to close the pocket for securing the item from exiting the pocket.

12. (canceled)

13. (canceled)

14. The system as set forth in claim 13 wherein the enveloping member is shaped to correspond to a shape of the item.

15. (canceled)

16. (canceled)
